(19) United States
(12) Patent Application Publication
(10) Pub. No.: US 2010/0101943 A1
(43) Pub. Date: Apr. 29, 2010

(54) RADIOACTIVE FLUORINE ANION CONCENTRATING DEVICE AND METHOD

(76) Inventors: Ren Iwata, Miyagi (JP); Eiichi Ozeki, Kyoto (JP); Hiroaki Nakanishi, Kyoto (JP); Katsumasa Sakamoto, Kyoto (JP); Ryo Yamahara, Kyoto (JP)

Correspondence Address: Cheng Law Group, PLLC, 1100 17th Street, N.W., Suite 503, Washington, DC, 20036, US

(21) Appl. No.: 12/532,957

(22) PCT Filed: Mar. 26, 2007
(86) PCT No.: PCT/JP2007/056160

§ 371 Date: Sep. 24, 2009

(51) Int. Cl. G21G 4/08

(52) U.S. Cl. 204/278.5

(57) ABSTRACT

A radioactive fluoride anion concentrating device capable of concentrating ¹⁸F⁻ ions speedily and efficiently. A flow cell (11) is composed of a metal plate electrode (21), an insulating sheet (23) and a carbon plate electrode (25) located so that the sides of electrodes may be opposed to each other with the insulating sheet (23) inserted between them. An example of the plate metal plate electrode (21) is obtained by forming a film of metallic material on an insulation plate, and an example of the insulating sheet (23) is a PDMS from which a groove being a channel (26) having a thickness of ≦500 μm is cut out. The thickness of the sheet is desirably about 100 μm. The upper and lower sides of the flow cell (11) are fixed by fixing jigs (27) and (29).

### TECHNICAL FIELD

The present invention relates to a radioactive fluoride anion concentrating device by which ¹⁸F⁻ ions obtained by irradiating [¹⁸O]H₂O with protons accelerated by a cyclotron are separated from the [¹⁸O]H₂O to produce an organic solvent solution containing the ¹⁸F⁻ ions.

### BACKGROUND ART

PET (Positron Emission Tomography) is one of the medical diagnostic techniques using radioactive tracer compounds, but most of the radioactive nuclides used in PET have relatively short half-lives. For example, the half-life of ¹⁸F⁻ is about 110 minutes. Therefore, it is necessary to efficiently introduce such a radioactive nuclide into a tracer compound in a short period of time to radioactivate the tracer compound.

Further, [¹⁸O]H₂O as a raw material of ¹⁸F⁻ ions is expensive, and therefore, there is a demand for reuse of [¹⁸O]H₂O to reduce the cost of diagnosis by PET.

A radioactive tracer compound used in, for example, PET has a time limit due to a short lifetime of a radioactive nuclide used, and therefore, the synthesis of a compound labeled with ¹⁸F is required to achieve both a reduction in time on the minute time scale and a high synthetic rate.

Conventional methods for separating ¹⁸F⁻ ions from [¹⁸O]H₂O containing ¹⁸F⁻ ions to produce an organic solvent solution containing the separated ¹⁸F⁻ ions can be divided into two types (hereinafter, referred to as “conventional method 1” and “conventional method 2”).

According to a conventional method 1, [¹⁸O]H₂O containing ¹⁸F⁻ ions is passed through a column packed with an anion-exchange resin to allow the resin to capture ¹⁸F⁻ ions to separate ¹⁸F⁻ ions from the [¹⁸O]H₂O. Then, the ¹⁸F⁻ ions captured by the resin are again eluted using an aqueous potassium carbonate solution, and the aqueous potassium carbonate solution containing ¹⁸F⁻ ions is recovered. Then, the recovered aqueous potassium carbonate solution is concentrated under reduced pressure to completely remove water, and then an organic solvent for performing an organic reaction is added thereto to obtain an organic solvent solution containing the separated ¹⁸F⁻ ions. The concentration of ¹⁸F⁻ ions in the organic solvent solution can be controlled by adjusting the amount of the organic solvent added.

According to a conventional method 2, ¹⁸F⁻ ions contained in [¹⁸O]H₂O are captured by a glassy carbon rod electrode, and then the solvent is exchanged from [¹⁸O]H₂O to an organic solvent. It can be expected that [¹⁸O]H₂O obtained by separating ¹⁸F⁻ ions from [¹⁸O]H₂O containing ¹⁸F⁻ ions by this method can be reused because it is free from eluted organic substances. A device for separating ¹⁸F⁻ ions from a [¹⁸O]H₂O solution containing ¹⁸F⁻ ions has been reported in Patent Document 1 and Non-Patent Document 1.

The basic structure of the device is described in detail in Non-Patent Document 1. The device uses a cell having a glassy carbon rod electrode and a platinum electrode. A voltage is applied to the glassy carbon rod electrode as a positive electrode to deposit ¹⁸F⁻ ions on the glassy carbon rod electrode to separate ¹⁸F⁻ ions from [¹⁸O]H₂O containing ¹⁸F⁻ ions. Then, the ¹⁸F⁻ ions deposited on the positive electrode are recovered using an organic solvent (dimethylsulfoxide (DMSO)) to react the ¹⁸F⁻ ions with an organic compound.

It is to be noted that a combination use of a graphite-like carbon electrode and a platinum electrode for depositing ¹⁸F⁻ ions on the graphite-like carbon electrode was first reported in Non-Patent Document 2.

Patent Document 1: Japanese Unexamined Patent Publication No. 2005-519270

Non-Patent Document 1: Appl. Radiat. Isot 2006 (64) 989-994.

Non-Patent Document 2: Appl. Radiat. Isot. 1989 (40) 1-6.

### DISCLOSURE OF THE INVENTION

### Problems to be Solved by the Invention

In the case of the conventional method 1, ¹⁸F⁻ ions can be speedily separated from [¹⁸O]H₂O containing ¹⁸F⁻ ions by an ion-exchange resin. However, as described above, many operational steps have to be performed to obtain an organic solvent solution containing ¹⁸F⁻ ions recovered from the ion-exchange resin, which takes much time. In addition, so many operational steps require the use of many tools and many kinds and large amounts of reagents. The separated [¹⁸O]H₂O cannot be reused because trace amounts of organic substances are eluted from the ion-exchange resin.

In the case of the conventional method 2, the cell described in the above documents is of a batch type, and therefore, capturing of ¹⁸F⁻ ions by the glassy carbon rod electrode cannot be performed in a state where [¹⁸O]H₂O containing ¹⁸F⁻ ions is flowing through the cell, and the amount of [¹⁸O]H₂O containing ¹⁸F⁻ ions that can be treated at one time is as small as about the internal volume of the cell. When a voltage of about 20 V is applied to the glassy carbon rod electrode, it takes about 8 minutes to trap ¹⁸F⁻ ions in the cell. Further, it takes about 5 minutes to recover ¹⁸F⁻ ions deposited on the glassy carbon rod electrode using an organic solvent.

The volume of the obtained organic solvent solution containing ¹⁸F⁻ ions is as large as about a fraction of the volume of the treated [¹⁸O]H₂O containing ¹⁸F⁻ ions, and therefore, the level of concentration of ¹⁸F⁻ ions is not so high.

Therefore, it is an object of the present invention to provide a radioactive fluoride anion concentrating device capable of concentrating ¹⁸F⁻ ions speedily and efficiently, and a radioactive fluoride anion concentrating method using such a device.

More specifically, it is an object of the present invention to achieve the following (1) to reduce the time required to separate ¹⁸F⁻ ions from [¹⁸O]H₂O containing ¹⁸F⁻ ions and recover the ¹⁸F⁻ ions using an organic solvent as compared to the conventional methods 1 and 2; (2) to separate ¹⁸F⁻ ions from [¹⁸O]H₂O containing ¹⁸F⁻ ions in a state where the [¹⁸O]H₂O is flowing through a cell so that a larger amount of [¹⁸O]H₂O containing ¹⁸F⁻ ions can be treated as compared to the conventional method 2; (3) to reduce an applied voltage required to separate ¹⁸F⁻ ions from [¹⁸O]H₂O containing ¹⁸F⁻ ions as compared to the conventional method 2; and (4) to reduce the volume of an obtained organic solvent solution containing ¹⁸F⁻ ions to achieve a higher level of concentration of ¹⁸F⁻ ions as compared to the conventional method 2.

### Means for Solving the Problems

The present invention is directed to a radioactive fluoride anion concentrating device including a flow cell having a pair of plate electrodes which are opposed to each other in parallel, and at least one of which is a carbon plate electrode, and a flow channel provided between the plate electrodes spaced 500 μm or less apart to allow a [¹⁸O]H₂O solution containing ¹⁸F⁻ ions to flow therethrough; a power source connected between the plate electrodes to apply a direct current voltage between the plate electrodes and capable of reversing the polarity of the direct current voltage; and a liquid sending device for sending the solution to the flow channel.

The carbon plate electrode may be a glassy carbon electrode or a graphite electrode. A first embodiment using a glassy carbon electrode as the carbon plate electrode of the flow cell and a second embodiment using a graphite electrode as the carbon plate electrode of the flow cell will be described later. The present invention can be carried out as long as at least one of the pair of plate electrodes contains carbon.

The other plate electrode may be, for example, a metal plate electrode obtained by forming a film made of a metal material on an insulating plate substrate. Examples of the metal material include platinum, gold, aluminum, tungsten, copper, silver, conductive silicon, titanium, and chromium.

The radioactive fluoride anion concentrating device according to the present invention may further include an insulating sheet having a through groove serving as the flow channel. In this case, the insulating sheet is sandwiched between the plate substrates. This is advantageous in that the flow channel can be provided between the plate electrodes without forming a groove or the like in one or both of the plate electrodes.

The present invention is also directed to a radioactive fluoride anion concentrating method using the radioactive fluoride anion concentrating device according to the present invention, the method including the steps of: capturing ¹⁸F⁻ ions by a carbon plate electrode, which is one of the pair of plate electrodes, by applying a voltage to the carbon plate electrode as a positive electrode and flowing a [¹⁸O]H₂O solution containing ¹⁸F⁻ ions as radioactive nuclides through the flow channel; and recovering a solution containing ¹⁸F⁻ ions or a reaction product labeled with ¹⁸F⁻ by applying a voltage to the carbon plate electrode as a negative electrode and flowing a solution for recovering ¹⁸F⁻ ions through the flow channel.

Examples of the solution for recovering ¹⁸F⁻ ions include a solution containing an agent for recovering ¹⁸F⁻ ions and a solution containing an organic reactive substrate.

### EFFECTS OF THE INVENTION

According to the present invention, the distance between the electrodes constituting the flow cell is 500 μm or less, and therefore, a potential gradient between the electrodes is large even when a voltage applied between the electrodes is low so that a large force acts on ¹⁸F⁻ ions. Further, by providing a space having a volume of several hundred microliters or less as the flow channel of the flow cell, it is possible to increase the specific surface area of the glassy carbon electrode per unit volume of the flow channel. Therefore, the radioactive fluoride anion concentrating device according to the present invention can achieve the following: (1) to treat [¹⁸O]H₂O containing ¹⁸F⁻ ions in a shorter period of time as compared to the conventional methods 1 and 2; (2) to treat a larger amount of [¹⁸O]H₂O containing ¹⁸F⁻ ions as compared to the conventional method 2; (3) to treat [¹⁸O]H₂O containing ¹⁸F⁻ ions at a lower applied voltage as compared to the conventional method 2; and (4) to reduce the volume of an obtained organic solvent solution containing ¹⁸F⁻ ions to achieve a higher efficiency of concentration of ¹⁸F⁻ ions as compared to the conventional method 2.

### BRIEF DESCRIPTION OF THE DRAWINGS

FIG. 1 is a schematic view showing a structure of a radioactive fluoride anion concentrating device according to one embodiment of the present invention.

FIG. 2 is an exploded perspective view of a flow cell of the radioactive fluoride anion concentrating device shown in FIG. 1.

FIG. 3A shows one example of a pattern of a flow channel formed in a PDMS sheet.

FIG. 3B shows another example of a pattern of a flow channel formed in a PDMS sheet.

FIG. 3C shows another example of a pattern of a flow channel formed in a PDMS sheet.

FIG. 4 is a graph showing results of a ¹⁸F⁻ ion capture experiment.

### DESCRIPTION OF THE REFERENCE NUMERALS

11 Flow cell
13 Power source
15 Liquid sending device
17 Drain
19 Heating device
21 Metal plate electrode
23 Insulating sheet
25 Glassy carbon electrode, graphite electrode

### DETAILED DESCRIPTION OF THE INVENTION

Hereinafter, embodiments of the present invention will be described in detail.

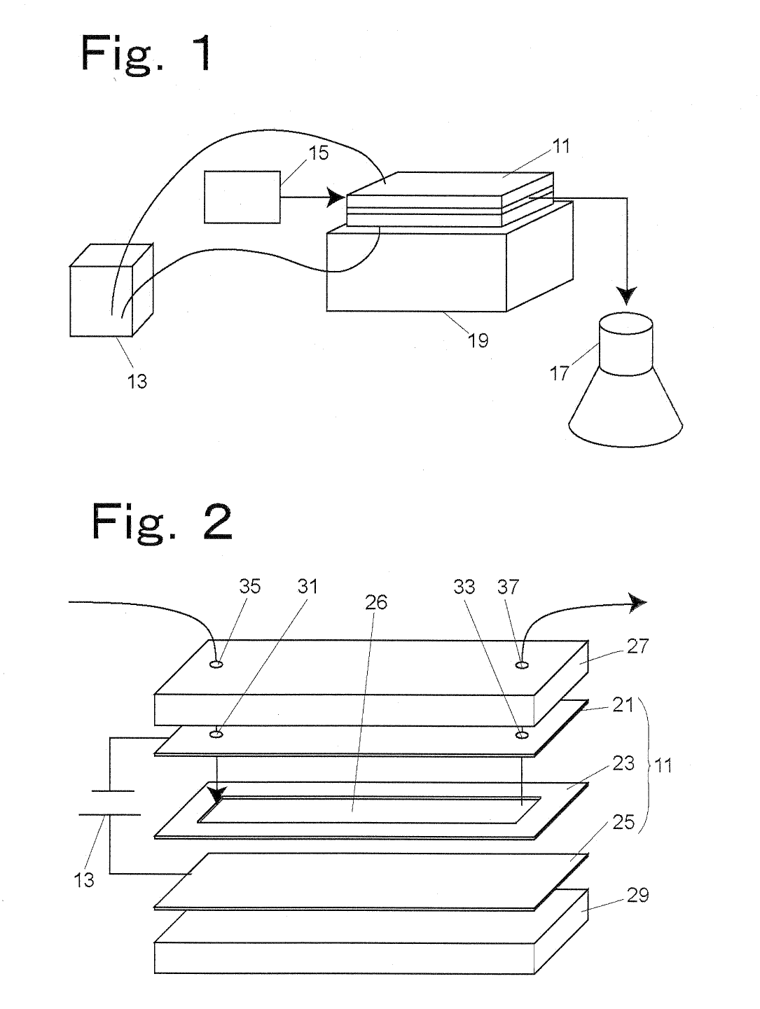

FIG. 1 is a schematic view showing a structure of a radioactive fluoride anion concentrating device according to a first embodiment of the present invention.

As shown in FIG. 1, the radioactive fluoride anion concentrating device includes a flow cell 11, a power source 13 for applying a direct current voltage to the flow cell 11, and a liquid sending device 15 for sending a solution to the flow cell 11. A solution sent to the flow cell 11 is recovered in a drain 17. The flow cell 11 is placed on a heating device 19 used as a temperature control device.

<Structure of Flow Cell>

FIG. 2 is an exploded perspective view of the flow cell 11 of the radioactive fluoride anion concentrating device according to the first embodiment of the present invention.

The flow cell 11 is constituted from a metal plate electrode 21, an insulating sheet 23, and a glassy carbon electrode 25. The electrodes 21 and 25 are arranged so that the electrode sides thereof are opposed to each other, and the insulating sheet 23 is sandwiched between the electrodes 21 and 25. In the flow cell 11 shown in FIG. 2, one of the electrodes is a glassy carbon electrode and the other electrode is a metal plate electrode, but both of the electrodes may be glassy carbon electrodes. That is, in the flow cell 11 to be used in the present invention, at least one of the two electrodes is a carbon electrode.

The metal plate electrode 21 can be obtained by, for example, forming a film made of a metal material (e.g., platinum, gold, aluminum, tungsten, copper, silver, conductive silicon, titanium, or chromium) on an insulating plate. The insulating sheet 23 can be obtained by, for example, forming a through groove serving as a flow channel 26 in a rubber sheet made of, for example, PDMS (polydimethylsiloxane). The thickness of the insulating sheet 23 varies depending on conditions for the use of the flow cell, but is preferably about 100 to 500 μm. The flow cell 11 is fixed by a fixing jig 27 provided on the upper surface of the flow cell 11 and a fixing jig 29 provided on the lower surface of the flow cell 11.

The metal plate electrode 21 has a sample inlet 31 and a sample outlet 33, and the inlet 31 is connected to one end of the flow channel 26 and the outlet 33 is connected to the other end of the flow channel 26. The fixing jig 27 has a through hole 35 connected to the sample inlet 31 and a through hole 37 connected to the sample outlet 33.

The power source 13 is connected between the metal plate electrode 21 and the glassy carbon electrode 25 to apply a direct current voltage between the electrodes 21 and 25. The power source 13 can reverse the polarity of the direct current voltage.

<Production of Flow Cell>

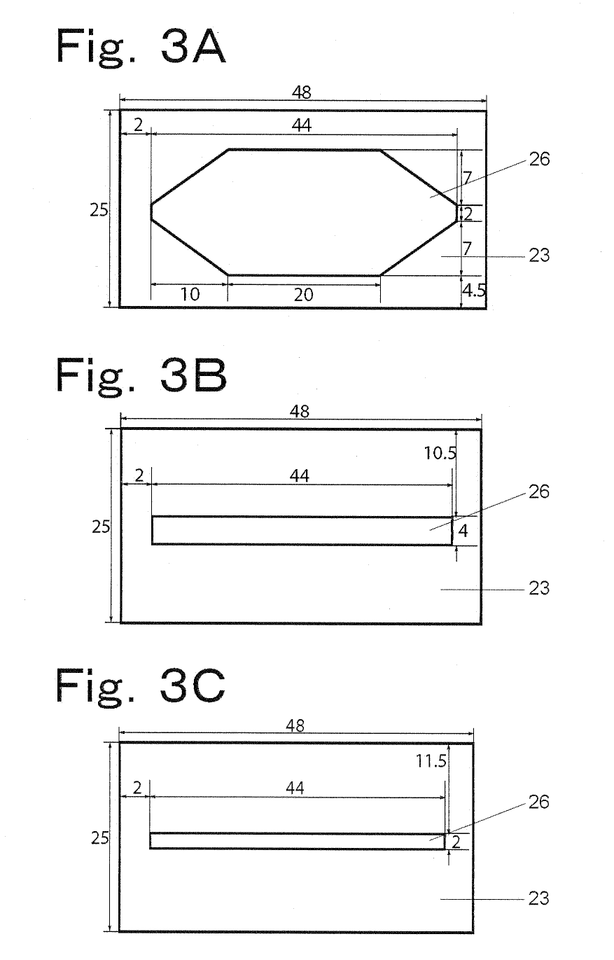

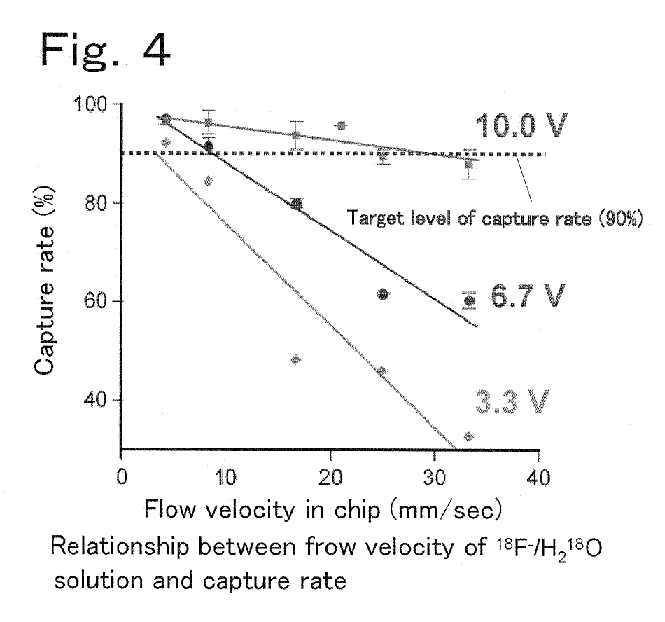

FIGS. 3A to 3C show examples of the pattern of the flow channel formed in the rubber (PDMS) sheet 23 of the radioactive fluoride anion concentrating device according to the first embodiment of the present invention.

As shown in FIG. 2, the flow cell is constituted from a chip (plate electrodes 21 and 25) and jigs for fixing the chip (fixing jigs 27 and 29). As shown in FIGS. 3A to 3C, the size of the chip is, for example, 25 mm×48 mm.

In the case of the flow channel pattern shown in FIG. 3A, the width of each of the ends of the flow channel 26 connected to the sample inlet 31 and the sample outlet 33 is 2 mm, and the width of the central portion of the flow channel 26 is 16 mm. In the case of the flow channel pattern shown in FIG. 3B, the width of the flow channel 26 is 4 mm. In the case of the flow channel pattern shown in FIG. 3C, the width of the flow channel is 2 mm. It is to be noted that the area ratio among the three flow channel patterns of the flow channel 26 shown in FIGS. 3A to 3C is 6:2:1.

In this case, as described above, the rubber sheet 23 for forming the flow channel 26 is made of PDMS, and the chip is formed by sandwiching the PDMS sheet 23 between the metal electrode 21 obtained by forming a metal electrode on a quartz member and the glassy carbon electrode 25.

Hereinafter, methods for forming members for use in the flow cell 11 will be described.

The metal plate electrode 21 is formed by sputtering a platinum film on a quartz member having a size of 25 mm×48 mm and a thickness of 1 mm obtained by dicing. As the glassy carbon electrode 25, a molded article having a size of 25 mm×48 mm and a thickness of 1 mm is used. The PDMS sheet 23 is formed by spin coating to have a thickness of 100 μm, and is then cut into pieces, each having a length of 25 mm and a width of 48 mm by a cutting plotter, and part of each of the pieces is cut out by the cutting plotter to form the flow channel 26 having a desired shape. The shape of the flow channel 26 will be discussed later.

Hereinafter, the procedure of assembling these members into the flow cell will be described.

(1) The metal plate electrode 21 and the PDMS sheet 23 having the flow channel 26 formed therein are subjected to oxygen plasma treatment to activate the surfaces thereof, and are then bonded together and left for 12 hours or longer to fix the metal plate electrode 21 and the PDMS sheet 23 to each other.

(2) The surface of the glassy, carbon electrode 25 and the surface of the PDMS sheet 23, which has been fixed to the metal plate electrode 21 in the above step (1), are subjected to oxygen plasma treatment, and are then bonded together immediately after the oxygen plasma treatment to fix the insulating sheet 23 and the glassy carbon electrode 25 to each other.

Hereinafter, the procedure of concentrating ¹⁸F⁻ ions will be described with reference to FIGS. 1 and 2.

### First Embodiment

(1) A solution containing ¹⁸F⁻ ions is introduced into the flow cell 11 through the sample inlet 31.

(2) The power source 13 applies a voltage between the metal plate electrode 21 and the glassy carbon electrode 25 to allow the glassy carbon electrode 25 to capture ¹⁸F⁻ ions.

(3) The solution contained in the flow channel 26 is discharged from the flow cell 11 through the sample output 33.

(4) The flow cell 11 is filled with acetonitrile containing an agent for recovering ¹⁸F⁻ ions, and then the polarity of the voltage applied to the glassy carbon electrode 25 is reversed to recover the ¹⁸F⁻ ions captured by the glassy carbon electrode 25 using the acetonitrile.

(5) The acetonitrile containing ¹⁸F⁻ ions is discharged from the flow cell 11 through the sample outlet 33.

(6) The flow cell 11 is filled with acetonitrile introduced through the sample inlet 31 to clean the inside of the flow cell 11.

(7) The cleaning fluid (acetonitrile) is discharged from the flow cell 11 through the sample outlet 33.

(8) The cleaning of the flow cell 11 with an acetonitrile solution is performed twice.

In a case where the flow cell 11 shown in FIG. 1 is used, a [¹⁸O]H₂O solution containing 18F⁻ ions is sent to the flow channel 26 by the liquid sending device 15, and is then recovered in the drain 17.

Hereinafter, one example of a fluorine concentration experiment performed according to the concentrating method described with reference to the first embodiment will be described with reference to FIGS. 1 and 2. It is to be noted that in this experiment, the flow channel 26 having the flow channel pattern shown in FIG. 3B was provided in the flow cell 11, and the glassy carbon electrode 25 was used as a carbon electrode.

<Concentration Experiment>

(1) A [¹⁸O]H₂O solution was introduced into the liquid sending device 15 (e.g., a syringe pump), and was then sent into the flow cell 11 using the syringe pump at a flow rate of 500 μL/min. The volume of the [¹⁸O]H₂O solution used was 2000 μL and the [¹⁸O]H₂O solution contained 1355 μCi of ¹⁸F⁻ ions.

(2) The direct-current power source 13 applied a voltage of 10.0 V to the glassy carbon electrode 25.

(3) After the completion of sending the [¹⁸O]H₂O solution to the flow cell 11, the [¹⁸O]H₂O solution was pushed out of the flow cell 11 by a compressed gas. The amount of ¹⁸F⁻ ions captured by the glassy carbon electrode 25 was 1238 μCi (which was measured after a lapse of 2 minutes from the initial dosimetry measurement).

(4) The flow cell was filled with 17.6 μL of an acetonitrile solution containing 0.34 mg of 4,7,13,16,21,24-hexaoxa-1,10-diazabicyclo-[8,8,8]-hexacosane (Kryptofix 222 (registered trademark), [K⊂2.2.2]₂CO₃). The polarity of the voltage applied by the direct-current power source 13 was reversed and a voltage of −3.3 V was applied to the glassy carbon electrode 25. The flow cell 11 was heated by the heating device 19 at 80° C. for 1 minute.

(5) After a lapse of 1 minute from the start of heating, the acetonitrile solution was pushed out of the flow cell 11 by a compressed gas and recovered. The flow channel 26 provided in the flow cell 11 was cleaned with 17.6 μL of an acetonitrile solution twice.

<Results of Concentration Experiment>

FIG. 4 is a graph showing results of the ¹⁸F⁻ ion capture experiment performed according to the concentrating method described with reference to the first embodiment.

The capture rate (%) of ¹⁸F⁻ ions by the glassy carbon electrode 25 at room temperature was determined by changing the applied voltage and the flow velocity of the [¹⁸O]H₂O solution in the chip (mm/sec). The voltage applied to the glassy carbon electrode 25 was changed at three levels (i.e., 3.3 V, 6.7 V, and 10.0 V), and as a result, the capture rate of ¹⁸F⁻ ions exceeded its target of 90% when the applied voltage was 10.0 V. Therefore, in the first embodiment, a voltage applied to the glassy carbon electrode 25 to allow the glassy carbon electrode 25 to capture ¹⁸F⁻ ions was set to 10.0 V.

On the other hand, a voltage of −3.3 V was applied to the glassy carbon electrode 25 while the flow cell 11 was heated at 80° C. for 1 minute when the ¹⁸F⁻ ions captured by the glassy carbon electrode 25 were recovered using a liquid for recovering ¹⁸F⁻ ions.

The amount of ¹⁸F⁻ ions recovered using the acetonitrile solution according to the concentrating method described above was 1032 μCi (which was measured after a lapse of 4 minutes from the initial dosimetry measurement). It is to be noted that in this experiment, the distance between the electrodes 21 and 25 of the flow cell 11 was 100 μm.

By setting the distance between the electrodes 21 and 25 of the flow cell 11 to 500 μm or less and providing a microspace having a volume of several hundred microliters or less as the flow channel 26, it is possible to maintain a large potential gradient between the electrodes 21 and 25 even at a low applied voltage, thereby increasing electrostatic force acting on ¹⁸F⁻ ions. This is attributed to an area where electrostatic force acts on ¹⁸F⁻ ions is increased by increasing the specific surface area of the electrode per unit volume of the flow channel.

According to the method described with reference to the first embodiment, the time required to treat 2.0 mL of the [¹⁸O]H₂O solution was reduced to about 4 minutes, which was shorter as compared to the conventional methods. Further, at this time, the amount of ¹⁸F⁻ ions captured by the glassy carbon electrode 25 was about 93% of the total amount of ¹⁸F⁻ ions contained in the [¹⁸O]H₂O solution, which was a sufficiently high capture rate.

Then, about 84% of the ¹⁸F⁻ ions deposited on the glassy carbon electrode 25 could be recovered using the acetonitrile solution. At this time, the time required to recover ¹⁸F⁻ ions using the acetonitrile solution was about 3 minutes.

The recovered acetonitrile solution containing ¹⁸F⁻ ions had a volume of about 53 μL and contained about 78% of the total ¹⁸F⁻ ions present in the [¹⁸O]H₂O solution.

The rate of change of the concentration of ¹⁸F⁻ ions was calculated as follows: 2000/53×0.78≅29. As a result, it was confirmed that the concentration of ¹⁸F⁻ ions was increased about 29 times.

Hereinafter, a radioactive fluoride anion concentrating device according to another embodiment of the present invention will be described.

### Second Embodiment

The radioactive fluoride anion concentrating device according to a second embodiment of the present invention has the same structure as the first embodiment shown in FIGS. 1 and 2, but the carbon plate electrode of the flow cell 11 is a graphite electrode 25.

The flow cell 11 has the metal plate electrode 21, the insulating sheet 23, and the graphite electrode 25. In the flow cell 11, the metal plate electrode 21 and the graphite electrode 25 are arranged so that the electrode sides thereof are opposed to each other, and the insulating sheet 23 is sandwiched between the metal plate electrode 21 and the graphite electrode 25.

It is to be noted that in the flow cell 11 shown in FIG. 2, one of the electrodes is a graphite electrode and the other electrode is a metal plate electrode, but one of the electrodes may be a glassy carbon electrode and the other electrode may be a carbon electrode, or both of the electrodes may be carbon electrodes.

Hereinafter, the procedure of concentrating ¹⁸F⁻ ions will be described with reference to FIGS. 1 and 2.

(1) A solution containing ¹⁸F⁻ ions is introduced into the flow channel 26 of the flow cell 11 through the sample inlet 31.

(2) The power source 13 applies a voltage between the metal plate electrode 21 and the graphite electrode 25 to allow the graphite electrode 25 to capture ¹⁸F⁻ ions.

(3) The solution contained in the flow channel 26 is discharged from the flow cell 11 through the sample outlet 33.

(4) An acetonitrile solution containing an agent for recovering ¹⁸F⁻ ions is introduced into the flow cell 11 through the sample inlet 31, and then the polarity of the voltage applied to the graphite electrode 25 is reversed to recover the ¹⁸F⁻ ions captured by the graphite electrode 25 using the acetonitrile solution.

(5) The acetonitrile solution containing ¹⁸F⁻ ions is discharged from the flow cell 11 through the sample outlet 33.

(6) Acetonitrile is introduced into the flow cell 11 through the sample inlet 31 to clean the inside of the flow cell 11 with the acetonitrile.

(7) The cleaning fluid (acetonitrile) is discharged from the flow cell 11 through the sample outlet 33.

(8) The cleaning of the flow cell 11 with an acetonitrile solution is performed twice.

In a case where the flow cell 11 shown in FIG. 1 is used, a [¹⁸O]H₂O solution containing ¹⁸F⁻ ions is introduced into the flow channel 26 by the liquid sending device 15, and is then recovered in the drain 17.

Hereinafter, one example of a fluorine concentration experiment performed according to the concentrating method described with reference to the second embodiment will be described with reference to FIGS. 1 and 2. It is to be noted that in this experiment, the flow channel 26 having the flow channel pattern shown in FIG. 3B was provided in the flow cell 11.

<Concentration Experiment>

(1) A [¹⁸O]H₂O solution was introduced into the liquid sending device 15 (syringe pump), and was then sent into the flow cell 11 by the syringe pump at a flow rate of 500 μL/min. The [¹⁸O]H₂O solution used had a volume of 2000 μL and contained 717 μCi of ¹⁸F⁻ ions.

(2) A voltage of 10.0 V was applied to the graphite electrode 25 by the direct-current power source 13.

(3) After the completion of sending the [¹⁸O]H₂O solution to the flow cell 11, the [¹⁸O]H₂O solution was pushed out of the flow cell 11 by a compressed gas. At this time, the amount of ¹⁸F⁻ ions captured by the graphite electrode 25 was 612 μCi (which was measured after a lapse of 2 minutes from the initial dosimetry measurement).

(4) The flow cell 11 was filled with 17.6 μL of an acetonitrile solution containing 0.34 mg of 4,7,13,16,21,24-hexaoxa-1,10-diazabicyclo-[8,8,8]-hexacosane (Kryptofix 222 (registered trademark), [K⊂2.2.2]₂CO₃). The polarity of the voltage applied by the direct-current power source 13 was reversed and a voltage of −3.3 V was applied to the graphite electrode 25. The flow cell 11 was heated by the heating device 19 at 80° C. for 1 minute.

(5) After a lapse of 1 minute from the start of heating, the acetonitrile solution was pushed out of the flow cell 11 by a compressed gas and recovered. The flow channel 26 of the flow cell 11 was cleaned with 17.6 of an acetonitrile solution twice.

<Results of Concentration Experiment>

The amount of ¹⁸F⁻ ions recovered using the acetonitrile solution according to the concentrating method described above was 313 μCi (which was measured after a lapse of 4 minutes from the initial dosimetry measurement).

According to the method described with reference to the second embodiment, the time required to treat the [¹⁸O]H₂O solution was shorter as compared to the conventional methods.

Further, in this experiment, the amount of ¹⁸F⁻ ions captured by the graphite electrode 25 was about 85.3% of the total amount of ¹⁸F⁻ ions contained in the [¹⁸O]H₂O solution, which was a sufficiently high capture rate.

Then, about 51.2% of the ¹⁸F⁻ ions deposited on the graphite electrode 25 could be recovered using the acetonitrile solution.

Hereinafter, the shape of the flow channel 26 provided in the flow cell 11 will be discussed.

<Study of Flow Channel Shape>

It can be estimated that ¹⁸F⁻ ion capture-efficiency is increased as the electrode area of the flow cell 11 is increased. Therefore, ¹⁸F⁻ ion capture efficiency was determined by changing the shape of the flow channel. In this study, three different flow channel patterns shown in FIGS. 3A to 3C were used. The area ratio among the three flow channel patterns shown in FIGS. 3A to 3C (i.e., electrode area ratio) was 6:2:1. The volume of a flow channel having the flow channel pattern shown in FIG. 3A was 50 μL, the volume of a flow channel having the flow channel pattern shown in FIG. 3B was 17.6 μL, and the volume of a flow channel having the flow channel pattern shown in FIG. 3C was 8.8 μL. The ¹⁸F⁻ ion capture rate by the glassy carbon electrode 25 (see FIGS. 1 and 2) was determined under conditions where an applied voltage was 3.3 V, a solution flow rate was 200 μL/min, and a reaction temperature was room temperature.

In the case of the flow channel patterns shown in FIGS. 3A and 3B, the ¹⁸F⁻ ion capture rates calculated under the above conditions exceeded 86%. In the case of the flow channel pattern shown in FIG. 3C, the ¹⁸F⁻ ion capture rate calculated under the above conditions was about 70%.

Then, radiographs (not shown) were taken to check the distribution of ¹⁸F⁻ ions in the flow channel patterns shown in FIGS. 3A to 3C. As a result, in the case of the flow channel pattern shown in FIG. 3A, it was suspected that air bubbles were present at the upper part of the side surface of the flow channel, and in addition, it was found that almost all the ¹⁸F⁻ ions were captured by part of the electrode located in the first half of the flow channel.

On the other hand, in the case of the flow channel patterns shown in FIGS. 3B and 3C, it was confirmed from the radiographs that there was no accumulation of air bubbles and capture of ¹⁸F⁻ ions was performed throughout the flow channel.

Based on the results, the most efficient flow channel pattern was selected from the three flow channel patterns. As described above, the flow channel pattern shown in FIG. 3A achieved a high ¹⁸F⁻ ion capture rate, but only a part of the surface of the electrode was used for capturing ¹⁸F⁻ ions and the presence of air bubbles was observed. Therefore, in the measurement to obtain the results shown in FIG. 4, the flow channel pattern shown in FIG. 3A was excluded from the selection. On the other hand, the flow channel pattern shown in FIG. 3C had a smaller width and achieved a lower capture rate as compared to the flow channel pattern shown in FIG. 3B. The experiment results may vary depending on experiment conditions, but in the measurement to obtain the results shown in FIG. 4, the flow channel pattern shown in FIG. 3C was also excluded from the selection.

As a result, the flow channel pattern shown in FIG. 3B was selected as the most efficient flow channel pattern, but it is supposed that the flow channel patterns shown in FIGS. 3A and 3C can also achieve good results depending on experiment conditions.

The flow cell produced according to the present invention is designed so as to be able to separate ¹⁸F⁻ ions from [¹⁸O]H₂O containing ¹⁸F⁻ ions in a state where the [¹⁸O]H₂O is flowing therethrough, and therefore, it is possible to treat a desired amount of [¹⁸O]H₂O containing ¹⁸F⁻ ions at one time to separate ¹⁸F⁻ ions from the [¹⁸O]H₂O.

In addition, it is also possible to speedily perform solvent exchange by allowing a desired organic solvent to flow through the flow channel, thereby simplifying operation as compared to the conventional method using an ion-exchange resin.

Further, by setting the distance between the electrodes 21 and 25 constituting the flow cell 11 to 500 μm or less, a large potential gradient between the electrodes 21 and 25 is maintained even when a voltage applied between the electrodes 21 and 25 is low. Therefore, a large electrostatic force acts on ¹⁸F⁻ ions so that the time required to capture ¹⁸F⁻ ions is reduced. Further, by providing a microspace having a volume of several hundred microliters or less as the flow channel 26 in the flow cell 11, the specific surface area of the carbon electrode 25 per unit volume of the flow channel is increased so that the ¹⁸F⁻ ion capture efficiency is enhanced.

Further, the volume of an organic solvent to be introduced into the flow channel to recover ¹⁸F⁻ ions captured by the electrode is reduced so that the efficiency of concentration of ¹⁸F⁻ ions is enhanced.

### INDUSTRIAL APPLICABILITY

The present invention can be applied to a flow cell for separating ¹⁸F⁻ ions obtained by irradiating [¹⁸O]H₂O with protons accelerated by a cyclotron from the [¹⁸O]H₂O to produce an organic solvent solution containing the ¹⁸F⁻ ions.

1. A radioactive fluoride anion concentrating device comprising:
a flow cell having a pair of plate electrodes which are opposed to each other in parallel, and at least one of which is a carbon plate electrode, and a flow channel provided between the plate electrodes spaced 500 μm or less apart to allow a [¹⁸O]H₂O solution containing ¹⁸F⁻ ions to flow therethrough;
an insulating sheet having a through groove serving as the flow channel, the insulating sheet being sandwiched between the plate electrodes and having a thickness of 500 μm or less to define the space between the plate electrodes;
a power source connected between the plate electrodes to apply a direct current voltage between the plate electrodes and capable of reversing a polarity of the direct current voltage; and
a liquid sending device for sending the solution to the flow channel.

2. The radioactive fluoride anion concentrating device according to claim 1, wherein the carbon plate electrode is a glassy carbon electrode.

3. The radioactive fluoride anion concentrating device according to claim 1, wherein the other plate electrode is a metal plate electrode obtained by forming a film made of a metal material on an insulating plate substrate.

4. (canceled)

5. A radioactive fluoride anion concentrating method using the radioactive fluoride anion concentrating device according to claim 1, the method comprising the steps of:
capturing ¹⁸F⁻ ions by a carbon plate electrode, which is one of the pair of plate electrodes, by applying a voltage to the carbon plate electrode as a positive electrode and flowing a [¹⁸O]H₂O solution containing ¹⁸F⁻ ions as radioactive nuclides through the flow channel; and
recovering a solution containing ¹⁸F⁻ ions or a reaction product labeled with ¹⁸F⁻ ions by applying a voltage to the carbon plate electrode as a negative electrode and flowing a solution for recovering ¹⁸F⁻ ions through the flow channel.

6. The radioactive fluoride anion concentrating method according to claim 5, wherein the solution for recovering ¹⁸F⁻ ions contains an agent for recovering ¹⁸F⁻ ions or an organic reactive substrate.

7. The radioactive fluoride anion concentrating device according to claim 1, wherein the carbon plate electrode is a graphite electrode.

8. The radioactive fluoride anion concentrating device according to claim 2, wherein the other plate electrode is a metal plate electrode obtained by forming a film made of a metal material on an insulating plate substrate.

9. The radioactive fluoride anion concentrating device according to claim 7, wherein the other plate electrode is a metal plate electrode obtained by forming a film made of a metal material on an insulating plate substrate.
